(19) United States
(12) Patent Application Publication
(10) Pub. No.: US 2012/0015172 A1
(43) Pub. Date: Jan. 19, 2012

(54) COMPOSITE MATERIAL AND PREPARING METHOD OF THE SAME

(75) Inventors: Chunnan Gao, Shenzhen (CN); Ping Lu, Shenzhen (CN); Aihua Li, Shenzhen (CN); Liang Chen, Shenzhen (CN)

(73) Assignee: BYD Company Limited, Shenzhen, Guangdong (CN)

(21) Appl. No.: 13/143,328

(22) PCT Filed: Jan. 6, 2010
(86) PCT No.: PCT/CN2010/070010

§ 371 Date: Jul. 5, 2011

(30) Foreign Application Priority Data
Jan. 6, 2009 (CN) 200910104942.3

(51) Int. Cl. B32B 3/26; C25D 11/18; C23C 28/00

(52) U.S. Cl. 428/304.4; 205/199; 205/202

(57) ABSTRACT

The present invention discloses a composite material comprising: a substrate with an anodic oxide film layer having micropores; and at least one kind of dye filled in the micropores, wherein amount of the same kind of dye is gradient distribution on at least part of the substrate. The composite material has an even, metal gloss, uneasily scratched and wore out surface with gradually changed color. Moreover, the present invention also provided a method of preparing the same.

### CROSS REFERENCE TO RELATED APPLICATION

This application claims priority to Chinese Patent Application No. 200910104942.3, filed on Jan. 6, 2009, the entirety of which is hereby incorporated by reference.

### FIELD OF THE INVENTION

The present invention relates to a composite material, more particularly to a composite material with gradually changed color.

### BACKGROUND OF THE INVENTION

The current method for preparing color oxide layer on the surface of aluminum or aluminum alloy based materials comprises the steps of: (1) forming an anodic oxide film layer by anodizing the aluminum or aluminum alloy surface in sulfuric acid; (2) dyeing the anodized oxidation film layer in a solution containing an organic dye, and sealing it to obtain various surface colors. However, this method can only form a single color, and it may not be used for forming multipule colors.

And currently, spraying or printing process is mainly used to form a gradient color layer on the aluminum or aluminum alloy surface. For example, the gradient change of single color may be obtained by controlling the thickness of the inks on the surface. However, the surface treated with spraying or printing process loses its metal gloss and hand feeling, and it is uneven and easily scratched or wore out.

### SUMMARY OF THE INVENTION

In view of thereof, the present invention aims to solve at least one of the problems existing in the prior art. Therefore, there remains an opportunity to provide a composite material with an even, metal gloss, uneasily scratched and wore out surface with gradually changed color and a method of preparing the same.

According to one aspect of the invention, a composite material comprises a substrate with an anodic oxide film layer having micropores; and at least one kind of dye filled in the micropores. The amount of the same kind of dye is gradient distribution on at least part of the substrate.

According to one embodiment of the invention, the substrate is aluminum or aluminum alloy.

According to another embodiment of the invention, two kinds of dyes is filled in the micropores, with the amount of one kind being gradient distribution in a direction along the substrate, while the other kind being gradient distribution in an opposite direction along the substrate.

According to another aspect of the invention, a method for preparing a composite material is provided, which comprises the steps of: providing a substrate; anodizing the substrate surface to form an anodized oxidation film layer having micropores; and dyeing the anodic oxide film layer by filling the micropores with at least one kind of dye. The dyeing time duration of different parts along the substrate is controlled to make amount of the same kind of dye gradient distribution on at least part of the substrate.

Other variations, embodiments and features of the present disclosure will become evident from the following detailed description.

### BRIEF DESCRIPTION OF THE DRAWINGS

These and other aspects and advantages of the invention will become apparent and more readily appreciated from the following descriptions taken in conjunction with the drawings in which:

FIG. 1 shows a composite material with gradually changed single color according to an embodiment of the invention.

### DETAILED DESCRIPTION OF THE PREFERRED EMBODIMENTS

It will be appreciated by those of ordinary skill in the art that the embodiments disclosed herein may be embodied in other specific forms without departing from the spirit or essential character thereof. The presently disclosed embodiments are therefore considered in all respects to be illustrative and not restrictive.

A composite material provided by the present invention may comprise a substrate with an anodic oxide film layer having micropores; and at least one kind of dye filled in the micropores. The amount of the same kind of dye is gradient distribution in at least part of the micropores.

The substrate can be aluminum or aluminum alloy.

The word ‘gradient’ refers to a change rate of the dye amount in the micropores. For example, the place of the anodic oxide film layer named Y contains dye with an amount of W, meanwhile its vertical place named dY with (W+dW), then ‘dW’ is named ‘gradient’ of the dye amount, namely the change rate of the dye amount.

In some embodiments, there are the two kinds of dyes filled in the micropores, with the amount of one kind gradiently distributed in a direction along the substrate, while the other kind gradiently distributed in an opposite direction along the substrate. There can also be more than two kinds of dyes, if only different kinds of dyes are all gradiently distributed in different directions along the substrate respectively. The dyes can have different color.

The gradually changed color may be formed on the substrate by forming the gradient distribution of the dyes. The gradually changed color refers to a color continuously changed from deep to light, or from light to deep, for example, gradually changed yellow is the color continuously changed from light yellow to deep yellow.

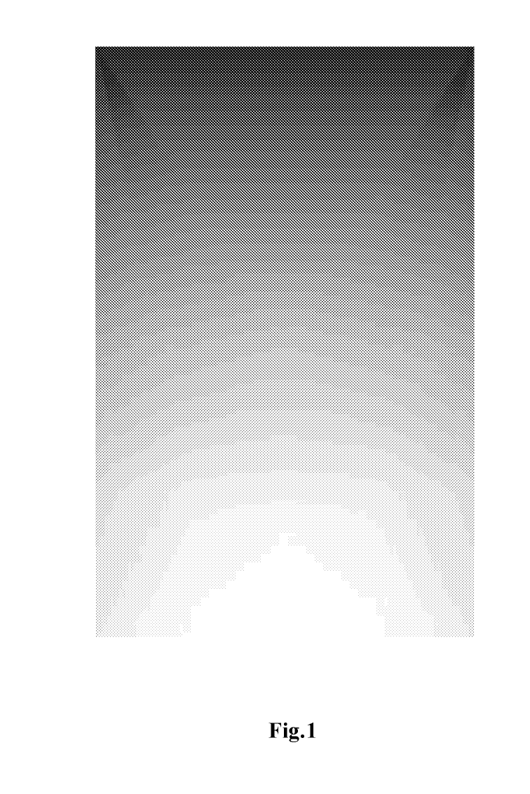

The whole substrate of composite material can be gradually changed color as shown in FIG. 1. In some embodiments, only part of the substrate of the composite material is gradually changed color, while other part is uniform color forming by general dyeing method. The gradients of the same kind of dye in one direction along the substrate may be the same or not, if only gradually changed color is formed. To make the gradually changed color looks more artistic, the gradients of the same kind of dye in one direction along the substrate should be the same.

The thickness of the anodic oxide film layer may be about 5 μm to about 15 μm. If the thickness of the anodic oxide film layer is too thin, the dyeing, particularly dyeing with deep color dyes, will be difficult and the surface capability will be less quality. Whereas if the anodic oxide film layer is too thick, the time duration of anodizing will be prolonged remarkably. In some embodiments, the thickness of the anodic oxide film layer may be about 11 μm to about 14 μm.

The dyes may be any in the prior art, including, without limited, azo dyes, anthraquinone dyes, nitro dyes and phthalocyanine dyes.

The present invention also provide a method for preparing a composite material, which comprises the steps of: providing a substrate; anodizing the substrate to form an anodic oxide film layer having micropores; and dyeing the anodic oxide film layer by filling the micropores with at least one kind of dye. The dyeing time duration of different parts along the substrate is controlled to make amount of the same kind of dye gradient distribution on at least part of the substrate. That is to say that the gradient distribution is obtained by controlling the different parts of the substrate's anodized oxidation film layer to be dyed for different time duration.

Particularly, the substrate is aluminum or aluminum alloy.

According to an embodiment of the present invention, the composite material with gradually changed single color, as shown in FIG. 1, may be obtained by controlling the anodized oxidation film layer immerged into one kind of dye in a first direction along the substrate with uniform speed.

After the above first dyeing, the amount of dye in deep colored area is enough to fill most of the micropores on the anodic oxide film layer, while the amount of dye in light colored area is less to fill most of them. So the light colored area has more micropores with more space for following dyeing.

If the composite material with gradually changed single color is further immerged into another kind of dye in a second direction by parallel rotation with an angle of 0° to 180° relative to the first direction, a composite material with gradually changed dual color will be obtained. According to one embodiment, the composite material with gradually changed single color may be immerged into another kind of dye in the direction opposite to the first direction, namely the parallel rotation angle is about 180°, to obtain a more aesthetic gradually changed dual color surface.

In some embodiments, the above dyeing process may be repeated for some times, with angles of parallel rotations all different from each other, to obtain a gradually changed multiple color surface.

The method of controlling the anodized oxidation film layer immerged into dyes with uniform speed may be achieved by any methods generally known in this field. In some embodiments, a lifting device is used for controlling the dyeing time duration of different parts of the anodized oxidation film layer along the substrate.

In some embodiments, the uniform speed may be about 0.015 m to about 0.02 m per minute.

Higher the dyeing temperature is, faster the dyeing speed is. But if the dyeing temperature is extremely high, the quality of the dyeing will be impairment. In some embodiments, the dyeing temperature may be about 25° C. to about 50° C.

In some embodiments, the liquid level of the dye is kept in a certain level during the dyeing step. The liquid level of the dye may increase with the entry of the anodized oxidation film layer. Thus, to keep the product's surface gradually changed in color, it will be better to keep the liquid level of the dye in a certain level.

In some embodiments, the method may include a sealing process after the dyeing. The sealing process is known in this field. For example, it may be carried out by placing the composite material into a sealing reagent with a concentration of about 5 to 10 g/L at about 80 to 100° C. for about 15 to 25 minutes, and then drying it in a baking oven at about 55 to 65° C. for about 10 to 15 minutes.

The anodizing technology may be a known method in this field. For example, it may be carried out by placing a substrate into an electrolyte as anode, and a steel plate is used as cathode. The electrolyte includes sulfuric acid solution with a concentration of about 100 to 200 g/L and aluminum sulfate of about 5 to 10 g/L. The DC power voltage may be about 10 to 15 V, and the anodizing time may be about 20 to 40 minutes.

In some embodiments, the substrate may be pre-treated before anodizing. The pretreatment may include the steps of:

(1) Dewaxing and Degreasing

The substrate is placed into a solution of degreasing powder with a concentration of 30-50 g/L at about 50-70° C. for about 3-8 minutes, and then the degreasing powder solution on the substrate surface is removed by water.

(2) Chemical Polishing

The above dewaxed and degreased substrate is placed into a mixed acid solution with a concentration of about 650-750 g/L phosphoric acid and about 150-250 g/L sulphuric acid for chemical polishing for about 3-7 seconds. After polishing, the substrate is immediately transferred into water to wash off the acid on the substrate surface. Then it is placed into a 7-15 g/L sodium hydroxide solution for about 5-15 minutes, and immediately transferred into water to wash off the alkali on the substrate surface.

The following are various embodiments of the composite material and preparation methods according to the present disclosure.

### Example 1

### 1. Pretreatment

(1) Dewaxing and degreasing

The substrate material is 6061 aluminum alloy. The substrate is placed into a solution of degreasing powder with a concentration of 40 g/L (LD-208; Deshen Chemical Industry Co., Ltd. Shenzhen) at about 60° C. for about 5 minutes, and then the degreasing powder solution on the substrate surface is removed by water.

(2) Chemical Polishing

The substrate is then placed into a mixed acid solution with a concentration of about 700 g/L phosphoric acid and about 200 g/L sulphuric acid for chemical polishing for about 5 seconds. After polishing, the substrate is immediately transferred into water to wash off the acid on the substrate surface. Then it is placed into a 10 g/L sodium hydroxide solution for about 10 minutes, and then immediately transferred into water to wash off the alkali on the substrate surface.

### 2. Anodizing

The substrate after pretreatment is placed into an electrolyte as anode, and a steel plate is used as cathode. The electrolyte includes sulfuric acid solution with a concentration of about 180 g/L and aluminum sulfate of about 8 g/L. The DC power voltage is about 13 V, and the anodizing time is about 35 minutes. An anodic oxide film layer with a thickness of about 13 mm is formed on the substrate surface, which it is placed into an oven and dried at 100° C. for 0.5 hours.

### 3. Dyeing

A yellow dye(Yellow 4G, Okuno New Technology Industries Co., Ltd. Hangzhou) with a concentration of about 5 g/L is used. The dyeing temperature is about 45 to 55° C., and pH 4.5 to 5.5. The substrate having uniform anodic oxide film layer is hanged on a lifting device. After the surface blowed dry by using compressed air, the hanging height of the substrate is gradually reduced by the lifting device with a uniform speed of about 0.018 m per minute to make the substrate gradually dipped into the dye. The deepest colored part of the substrate is dyed for about 3 minutes, and the lightest colored part is dyed for about 5 seconds. The liquid level of the dye is kept in a certain level during the dyeing. The substrate is then taken out rapidly, washed, and sealed using a sealing agent (TOP DX-500, Okuno New Technology Industries Co., Ltd. Hangzhou) for 15 minutes.

The composite material is labeled B1.

### Example 2

The steps 1 and 2 are the same as those used in EXAMPLE 1.

3. Dyeing

A violet dye and a blue dye are used (Violet SLH; Blue 503; Okuno New Technology Industries Co., Ltd. Hangzhou) with concentrations of about 5 g/L respectively. The dyeing temperature is about 45 to 55° C., and pH 4.5 to 5.5. The substrate having uniform anodic oxide film layer is hanged on a lifting device. After the surface blowed dry by using compressed air, the hanging height of the substrate is gradually reduced by the lifting device with a uniform speed of about 0.018 m per minute the to make the substrate gradually dipped into the violet dye. The deepest color part of the substrate is dyed for about 4 minutes, and the lightest color part is dyed for 1 seconds. The liquid level of the violet dye is kept in a certain level. The substrate is then taken out rapidly, washed and dried.

Then the substrate is rotated in parallel with an angle of about 180° relative to the violet dyeing direction, and gradually dipped into the blue dye by the lifting device. The deepest color part of the substrate is dyed for about 3 minutes, and the lightest color part is dyed for 1 seconds. The liquid level of the blue dye is kept in a certain level. The substrate is then taken out rapidly, washed, and sealed using a sealing agent (TOP DX-500, Okuno New Technology Industries Co., Ltd. Hangzhou) for 15 minutes.

The composite material is labeled B2.

### REFERENCE 1

The steps 1 and 2 are the same as those used in EXAMPLE 1.

3. Dyeing

A yellow paint (AkzoNobel Chemical Co., Ltd. Guangdong) is sprayed on the substrate surface, and the spayed time is controlled to obtain a gradient color layer.

The composite material is labeled D1.

Testing

1. Glossiness Testing

The glossiness of B1, B2 and D1 is tested at a temperature of 60° C. using A-4460 Lustre Meter (BYK Co. Germany). The instrument parameters include: aperture: 4 mm; light source: D65; observed angle: 10°; and without specular reflection. The results are shown in table 1. The larger the glossiness is, the better the gloss is.

2. Wear Resistance Testing

The wear resistance of materials B1, B2 and D1 is tested by 7-1 BB paper tape wear tester (Unkel Co., Ltd. Foshan). The worn-out circle numbers are shown in table 1. The larger the circle number is, the better the wear resistance performance is.

3. Salt Mist Endurance Testing

NaCl aqueous solutions with a mass fraction of about 5% is sprayed on the materials B1, B2 and D1 at 35° C. in a salt-mist corrosion tester for 16 hours. The materials are taken out and placed into a constant temperature and humidity chamber with a temperature of 40° C. and a relative humidity of 80%. The time durations when the substrate surface becomes abnormal are recorded and shown in table 1. The longer the time duration is, the better the resistance to corrosion of the film layer is.

TABLE 1

| | | Wear | Salt Mist | |
|---|---|---|---|---|
| | Glossiness | Resistance | Endurance | |
| | (Gs) | (Circle) | (Hour) | Appearance |
| B1 | 59.3 | 2550 | 353 | Smooth |
| B2 | 58.7 | 2540 | 350 | Smooth |
| D1 | 35 | 1200 | 320 | Pits |

As shown in table 1, the composite materials B1 and B2 have better coating qualities than D1.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A composite material comprising:
a substrate with an anodic oxide film layer having micropores; and
at least one kind of dye filled in the micropores, wherein amount of the same kind of dye is gradient distribution on at least part of the substrate.

2. The composite material of claim 1, wherein the substrate is aluminum or aluminum alloy.

3. The composite material of claim 1, wherein two kinds of dyes is filled in the micropores, with the amount of one kind being gradient distribution in a direction along the substrate, while the other kind being gradient distribution in an opposite direction along the substrate.

4. The composite material of claim 1, wherein the same kind of dye distribution in one direction along the substrate is in the same gradient.

5. The composite material of claim 1, wherein the anodic oxide film layer has thickness of about 5 μm to about 15 μm.

6. The composite material of claim 1, wherein the dye is selected at least one from the group consisting of azo dyes, anthraquinone dyes, nitro dyes, and phthalocyanine dyes.

7. A method for preparing a composite material, comprising the steps of:
providing a substrate;
anodizing the substrate to form an anodic oxide film layer having micropores;
and dyeing the anodic oxide film layer by filling the micropores with at least one kind of dye, wherein dyeing time duration of different parts along the substrate is controlled to make amount of the same kind of dye gradient distribution on at least part of the substrate.

8. The method of claim 7, wherein the substrate is aluminum or aluminum alloy.

9. The method of claim 7, wherein the step of dyeing comprises controlling the anodized oxidation film layer immerged into one kind of dye in a first direction along the substrate with uniform speed to obtain a composite material with gradually changed single color.

10. The method of claim 9, wherein the step of dyeing further comprises controlling the anodized oxidation film layer of the composite material with gradually changed single color immerged into another kind of dye in a second direction by parallel rotation with an angle of 0° to 180° relative to the first direction with uniform speed to obtain a composite material with gradually changed dual color.

11. The method of claim 10, wherein the angle of parallel rotation is 180°.

12. The method of claim 10 the step is repeated for more than one time to obtain a composite material with gradually changed multiple color, wherein the angles of parallel rotations are all different from each other.

13. The method of claim 9, 10 or 12, wherein the uniform speed is about 0.015 m to about 0.02 m per minute.

14. The method of claim 7, wherein the dye is selected at least one from the group consisting of azo dyes, anthraquinone dyes, nitro dyes, and phthalocyanine dyes.

15. The method of claim 7, wherein temperature of the dyeing step is about 25° C. to about 50° C.

16. The method of claim 7, wherein liquid level of the dye is kept in a certain level during the dyeing step.
